(19) United States
(12) Patent Application Publication
(10) Pub. No.: US 2013/0304659 A1
(43) Pub. Date: Nov. 14, 2013

(54) INTEGRATED UNEMPLOYMENT AND RE-EMPLOYMENT SYSTEM

(71) Applicant: Paul Toomey, Palm Harbor, FL (US)

(72) Inventor: Paul Toomey, Palm Harbor, FL (US)

(21) Appl. No.: 13/468,440

(22) Filed: May 10, 2012

(51) Int. Cl. G06F 17/30; G06Q 10/06

(52) U.S. Cl. 705/321; 707/705; 707/E17.032

(57) ABSTRACT

The present invention provides a system for accessing unemployment insurance and workforce registration comprising in combination a database containing unemployment insurance benefit data and a database containing workforce registration data. A server having a software employment component is operatively coupled to the database containing unemployment insurance benefit data and is operatively coupled to the database containing workforce registration data. A computer access terminal is operatively coupled to the software employment component. The computer access terminal allows a first user to enter data into the database containing unemployment insurance benefit data and into the database containing workforce registration data.

### FIELD OF THE INVENTION

The present invention relates to a computerized system for both Workforce registration and the filing of unemployment claims.

### BACKGROUND OF THE INVENTION

When you find yourself unemployed and in need of employment services, two questions demand immediate attention:

1. Do I qualify for Unemployment Insurance Benefits?

2. What services are available to help me get back to work?

Currently, in order to find satisfactory answers to these questions, you must contact two distinct government agencies: those charged with handling Unemployment Insurance (UI), and those charged with providing Workforce services (often through One-Stop Career Centers).

In calendar year 2010, the State of Florida paid over $2.2 billion in total regular Unemployment Compensation (unemployment compensation) benefits. The over one million recipients of those benefits stayed on the unemployment rolls for an average of just over 18 weeks. The payment of unemployment compensation is a vital and necessary lifeline to those unemployed workers as a bridge to their next job. It is good social policy that this period of unemployment is brief, and that workers find suitable replacement jobs in a reasonable amount of time. It is also good fiscal policy for employers that unemployed workers find new jobs quickly. The fewer benefits paid to workers, the lower the employer tax rates will be and the longer state trust funds will remain solvent.

Emphasizing re-employment is a primary focus of the U.S. Department of Labor's (DOL) Employment and Training Administration (ETA). In its September 2010 report, “A National Call for Innovation—Rethinking Reemployment Services for UI Claimants,” ETA discusses the importance of the connectivity between the unemployment compensation and Workforce systems in putting unemployed individuals back to work.

Nothing in the prior art provides the benefits attendant with the present invention.

Therefore, it is an object of the present invention to provide an improvement which overcomes the inadequacies of the prior art methods and which is a significant contribution to the advancement to re-employing those individuals that have become unemployed.

Another object of the present invention is to provide a system for accessing unemployment insurance and workforce registration comprising in combination: a database containing unemployment insurance benefit data; a database containing workforce registration data; a server having a software employment component, said software employment component operatively coupled to said database containing unemployment insurance benefit data and said software employment component operatively coupled to said database containing workforce registration data; and a computer access terminal operatively coupled to said software employment component, said computer access terminal allowing a first user to enter data into said database containing unemployment insurance benefit data and said computer access terminal allowing the first user to enter data into said database containing workforce registration data.

Still yet another object of the present invention is to provide a system for accessing unemployment insurance and workforce registration comprising in combination: a database containing unemployment insurance benefit data; a database containing workforce registration data; a server having a software employment component, said software employment component operatively coupled to said database containing unemployment insurance benefit data and said software employment component operatively coupled to said database containing workforce registration data; a computer access terminal operatively coupled to said software employment component, the computer access terminal allowing a first user to log on and enter data into said database containing unemployment insurance benefit data and the computer access terminal allowing the first user to log on and enter data into said database containing workforce registration data, the computer access terminal allowing a second user to log on and review unemployment claims; and a dashboard operatively coupled to the computer access terminal.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The present invention provides a single point for both workforce registration and the filing of unemployment claims. Allowing individuals to enter information in one location removes the inconsistency that occurs through multiple data entry and data sharing, thereby improving the accuracy and effectiveness of the data in the workforce system. By requiring that unemployed individuals and employers enter key information in one location, the inconsistency that occurs through multiple data entry and data sharing can be removed, thereby improving the accuracy and effectiveness of the data in the workforce system.

Another feature of the present invention is to provide a system for accessing unemployment insurance and workforce registration. The system comprising in combination a database containing unemployment insurance benefit data and a database containing workforce registration data. A server having a software employment component which is operatively coupled to the database containing unemployment insurance benefit data and operatively coupled to the database containing workforce registration data. A computer access terminal is operatively coupled to the software employment component which allows a first user to enter data into the database containing unemployment insurance benefit data and the database containing workforce registration data. The first user can be an unemployed individual. A unified message center can be displayed on the computer access terminal. A calendar can be displayed on the computer access terminal. The first user can update personal information on a status screen that is generated on the computer access terminal. A list of available jobs for the first user can be displayed on the computer access terminal. A dashboard can be accessed by the first user on the computer access terminal. The dashboard can display on the computer access terminal weekly certifications, outstanding claim issues, payments, adjustments and overpayments. The dashboard can display on the computer access terminal benefit amount, effective dates and base period wages. The dashboard can allow the first user access to an employment plan. The employment plan can comprise job applications, resumes and a virtual recruiter. The dashboard can allow the first user access to a benefits plan. The dashboard can allow the first user access to workforce functionality. The workforce functionality can comprise job market, virtual recruitment, new careers and training classes. The dashboard can allow the first user access to unemployment services. The unemployment services can comprise weekly certifications. The system can include a second user which can be an employer. The second user can use the computer access terminal to post a job, search for a candidate and review unemployment claims on the status screen.

Still yet another feature of the present invention is to provide a system for accessing unemployment insurance and workforce registration. The system comprising in combination a database containing unemployment insurance benefit data and a database containing workforce registration data. A server having a software employment component is operatively coupled to the database containing unemployment insurance benefit data and is operatively coupled to the database containing workforce registration data. A computer access terminal is operatively coupled to the software employment component which allows a first user to log on and enter data into the database containing unemployment insurance benefit data and enter data into the database containing workforce registration data. The computer access terminal also allows a second user to log on and review unemployment claims. A dashboard is operatively coupled to the computer access terminal. The dashboard can display on the computer access terminal weekly certifications, outstanding claim issues, payments, adjustments and overpayments. The computer access terminal can display a list of available jobs to the first user at log on. The first user can have access to online job searching at log on. The system can electronically store the first user's job search and allow the first user to use the stored job search for fulfilling weekly job search requirements for unemployment benefits.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1A is a flow diagram illustrating an embodiment of the present invention;

FIG. 1B is a continuation of the flow chart of FIG. 1A;

FIG. 1C is a continuation of the flow chart of FIG. 1B;

FIG. 1D is a continuation of the flow chart of FIG. 1C; and

FIG. 1E is a continuation of the flow chart of FIG. 1D.

Similar reference characters refer to similar parts throughout the several views of the drawings.

### DETAILED DESCRIPTION OF THE INVENTION

In the present invention, when an individual logs on to file an unemployment insurance claim, they complete a workforce (Wagner-Peyser) application plus some additional questions required for unemployment insurance claims. When they complete the unemployment insurance application, a Wagner-Peyser registration is automatically created. The present invention saves a copy of the unemployment insurance registration, and passes the unemployment insurance application to the state unemployment insurance system for subsequent unemployment insurance processing. In another scenario, if an individual already has a Workforce registration and returns to complete an unemployment insurance application, the application form pre-populates with all of the common data elements, allowing any updates to be entered. In both scenarios, duplicate data entry is avoided, resulting in fewer inconsistencies and saved staff resources.

The present invention at log on can present the unemployed individual with a listing of jobs close to their home that match their background. The present invention can show the unemployed individual suitable job openings before their claim is even processed.

The present invention can repeatedly display jobs for the unemployed individual that closely matches their current occupation. The system can also show jobs that are related to their current occupation, or those that match their skills. The unemployed individual can be shown these job openings every time they enter the system, including during their weekly certification.

Using the present invention, the unemployed individual can explore multiple job openings and career paths that they may not have been aware existed. The system can find new careers for long term unemployed individuals that are unable to find a suitable job in their previous occupation, salary, or location.

The present invention can track all the jobs that an unemployed individual views and applies for online. The system can monitor a series of thresholds set for the unemployed individual, such as the number of jobs viewed, contacts made, etc. The system can also monitor other important factors for rapid re-employment, including if the unemployed individual has an active online resume.

The present invention can automatically detect if the unemployed individual has failed to appropriately seek work in a set period of time and can notify the individual that they are not meeting the requirement. These notifications can be sent to the unemployed individual through a variety of methods, including internal system message, email, postal mail, fax, and text message. The present invention can also alert the unemployment compensation system in real time and stop payments until the issue can be investigated and resolved. Automated notifications can also be sent to automatically follow up with employers via messages and email to verify unemployed individuals work search certifications. The number of overpayments because of work search verification issues could be significantly reduced.

The present invention can allow unemployed individuals to assess their skills, interests, and what is important to them in a job, and then locate matching opportunities. Unemployed individuals can be guided to occupations that are in demand and provide high paying jobs.

Unemployed individuals must make a verifiable search for work each week and provide a certification of availability for work. The present invention simplifies the weekly certification process by providing an online location for this certification in the workforce system. Any employer contacts that have been made can be displayed each time the unemployed individual completes their certification for benefits. The contacts made are proof that the unemployed individual is meeting their burden to seek suitable work. A comparison can be run to ensure that unemployed individuals are looking for jobs they are qualified for and not just going through the motions. If an unemployed individual refuses a job referral, the present invention can prevent a successful certification.

The present invention can continually display training opportunities to the unemployed individual that may effectively assist them in their goal of rapid re-employment. This can include traditional training onsite in local facilities as well as free online training courses. The unemployed individual's progress in these online courses can be monitored by staff with the appropriate privilege.

When unemployed individuals need specific information regarding their benefit claim, it is available through the dashboard of the present invention. The unemployed individual can view information on their benefit amount, effective dates and base period wages. They can also view current information on weekly certifications, outstanding claim issues, payments, adjustments and overpayments. They even have the ability to update their personal information directly from the status screen.

For employers, the present invention allows them to post a job, search for a candidate, and review unemployment insurance claims on their account. If they feel an unemployment insurance claim is incorrect, they can file an appeal using the present invention. Also, when they post a job or search for candidates, they now have access to a much broader variety of jobseekers. And because the present invention includes an employment and education history of all registrants, employers can view more detailed information on each jobseeker.

The present invention allows qualified staff from both workforce and unemployment insurance agencies to review the status of an unemployed individual's efforts to find work, and to set thresholds in the system. To facilitate the review and analysis of work search activity, the present invention supplies key re-employment metrics, such as, the number of jobs viewed, the number of jobs applied for, the number of active résumés, etc. Staff can use these and other metrics to set thresholds for acceptable unemployed individual job search activity. When a specified threshold is not met, the present invention can create an alert and/or send the unemployed individual a notification using the internal messaging system, email, postal mail, fax, or text messages. What's more, it is possible to increase the severity of the alerts or notifications the longer the unemployed individual fails to meet the thresholds.

Because the present invention can regularly transfer data on an unemployed individual's job search status to the unemployment insurance side, unemployment insurance staff can more efficiently enforce work search requirements, with enormous potential for savings in benefit payments. For example, many states require unemployment insurance applicants to complete an employment service registration before receiving benefits. This requirement often goes unverified, leading to millions of dollars in improper payments. Also, current unemployed individuals must not refuse a suitable job offer from a potential employer or a suitable job referral from the employment service. With the present invention, any of these requirements can be enforced using an alert to the unemployment insurance system to create an issue, thus stopping payments until the issue is investigated and resolved. In this way, the present invention can be used to prevent improper certifications in real time, significantly reducing the number of overpayments due to work search verification issues.

The present invention can also support an automated registration entry option that allows the unemployed individual to choose to parse/import data from an existing electronic source or file, such as a Word file or an HTML resume. The system can extract key information such as employment and education histories from an individual's digital resume. This information is then reviewed by the individual and electronically stored.

The present invention can directly help unemployed individuals make intelligent choices about their local job market, including the kind of jobs they should be looking for, where they should be looking for these jobs, who the major local employers are, and how much money they can expect to make. This kind of assistance is vital in rapidly finding an unemployed individual a suitable job. Included are the following features:
Maps, tables and graphs indicating where the hot job locations in the state are for the unemployed individual's desired occupation.
A detailed breakdown of the requirements for specific jobs.
Maps, tables and graphs indicating the locations in the state with the highest competition for the unemployed individual's desired occupation.
Analysis of the education level, work experience, and salary requirement of the unemployed individual's competition.
A review of the unemployed individual's salary requirements to see if they are reasonable.
A list of major employers that are currently hiring in the unemployed individual's desired occupation.

The present invention can provide tools for the unemployed individual to analyse their own skills and attributes together with the local labor market conditions to make an informed career choice. It includes a step-by-step guide to selecting a career, and a section to analyse a person's skills and match those skills to a suitable occupation. Additionally, unemployed individuals may review profiles of occupations and analyse, in detail, labor market information on occupations for their region or for the entire state.

The present invention includes an advanced self-assessment tool to help unemployed individuals determine their suitability for selected occupations based on their job skills, personal skills, interests, and/or what is important to them in a job. The self-assessment tool also identifies gaps in the skills required for certain occupations.

The present invention can quickly and easily display the latest local labor market information to the unemployed individual to help them make an informed decision as they look at jobs and new careers. This includes questions such as:
What are the highest paying jobs in an area?
What occupations have the highest employment in an area?
What is the unemployment rate in an area?
What occupations are predicted to have the most future job openings in an area?

The present invention can present the unemployed individual with different training and educational programs related to their occupation. They can research the different schools for these programs and look at information about job placement of graduates. The present invention can continually display training opportunities that may effectively assist the unemployed individual in their goal of rapid re-employment. This can include traditional training in onsite local facilities as well as free online training courses. The unemployed individual's progress in these online courses can be monitored by staff with the appropriate privilege.

The present invention can allow unemployed individuals to determine their budget and calculate the amount of money they need for training or from a potential job. The system allows an individual to create a basic budget plan based on their finances. The unemployed individual can be guided by a wizard that prompts them to enter detailed data on their income and expenses. The system then summarizes their financial situation, showing if they have a monthly surplus or deficit. The system displays the hourly income needed in order to meet the unemployed individual's financial goals. The individual can then select a link to find careers and jobs that meet their financial needs.

The present invention can recommend the unemployed individual view and access other resources based on the information that is provided as part of registration. For example, if they indicate that they are a veteran, they may see a link to a Veterans Services section. If they are under the age of 18, they may see a link to a Youth Services section.

The present invention can provide an online series of screens to allow the unemployed individual to submit their weekly certifications. The unemployed individual answers the appropriate questions about availability, earnings, and, when appropriate, job seeking activity.

The present invention pre-populates Job Search Employment information when the unemployed individual seeks and applies for jobs. It also captures all job search employment information that takes place outside of the system. It can automatically tie these entries to information on the employer in the comprehensive employer database. This can provide staff with details on the contact person at that organization.

When selected, staff can view a summary of the unemployment compensation claim and more detailed information concerning the claim. The present invention provides detailed claim information concerning the following areas:
Issues
Base Period Employment
Weekly Certification (Summary and Detail)
Payments (Summary and Detail including Adjustments when available)
Overpayments (Summary)
Employer Charge (Summary)
Payment Register (Summary)
Appeal (if Appeal Exists)

The present invention can provide detailed re-employment and work search information concerning the following areas:
Employment Status
Unemployment Status
Time period
Date of Last Activity
Date Last Logged in
Number of Logins
Number of jobs viewed over the time period
Date and time last job was viewed
Number of jobs applied for over the time period (internal and external jobs)
Date and time of last job application
Number of interviews over the time period
Number of active recruiters over the time period (includes if they have been run)
Number of active resume's (online and offline)
Date resume was last changed
Number of active letters over the time period

While using the present invention, the unemployed individual's job search activities are captured. The present invention allows staff to set thresholds concerning job search activities. These include:
Date of Last Activity
Number of Jobs Viewed per Week
Number of Jobs Applied for per Week
Number of Active Virtual Recruiters
Number of Active Résumés
Number of Active Letters

If any of these thresholds are not met be an unemployed individual during a set period of time, staff is notified. The present invention provides staff the ability to review an unemployed individual's Work Search Status at any time. In addition, staff has the ability to send notifications to unemployed individuals when they are not meeting Work Search Thresholds. These notifications are designed to allow staff to increase the severity of the notification the longer the unemployed individual does not meet the thresholds. These notifications can be sent through a variety of methods, including internal system message, email, postal mail, fax, and/or text message.

In the present invention, both workforce and unemployment compensation staff can assist unemployed individuals in maximizing their job search activities. The system can ensure that unemployed individuals are meeting their job search requirements and can create alerts when minimum job search requirements are not met. Workforce and unemployment compensation staff can have information available for statistical analysis of job search efforts and its relationship to acquiring new employment.

The present invention can provide unemployed individuals complete summary information on their unemployment compensation Benefit Claim in the following areas:
Claimant Details
Claim Details
Benefit Certifications
Payment Summary
Adjustment Summary
Overpayments
Outstanding Claim Issues, and
Employers and Income during Base Period

The present invention can ensure that unemployed individuals have access to current information on their claim and have the ability to modify their personal information directly from the status screen. The present invention can provide unemployed individuals' benefits claim information that currently is not readily available on a website.

The present invention system can be enhanced with the unemployed individual's Unemployment Status screen sets and supporting table structure to allow unemployed individuals to view their unemployment claim information.

The present invention system includes Claimant's Dashboard screen sets to allow unemployed individuals to view all the information available to them through their use of the present invention. They can review their job market, set up virtual recruitments, explore new careers, take training classes, build a resume, and other activities. The unemployed individual would also have the ability to review Unemployment Services to include File an unemployment compensation Claim, Complete Weekly Certifications, File an Appeal, and possibly complete an Eligibility Review questionnaire. They would have immediate access to their employment plan (Job Applications, Résumés, and Virtual Recruiter); their Benefits Plan; and access to their Message Center and Calendar. The dashboard also offers unemployed individuals the flexibility of configuring its components to their desired view by “drag and dropping” the component.

Using the present invention, unemployed individuals would go to a single location, “My Dashboard,” to view the status of all their system activity to date. The dashboard would also provide a springboard for job seekers to search for jobs, review the job market, explore new careers, participate in online training, analyse the labor market, review unemployment assistance, plan their finances, review benefits availability, and access other services.

The present invention can present employers with a personalized dashboard. This screen set is displayed every time the employer signs in to the system. This allows employers to view all the information available to them through their use of the present invention. In addition to the major services previously discussed, employers—when accessing the function in Unemployment Services—would have immediate access to:
Claimant benefits charged to their company
A roster of all the unemployed individuals filing for Unemployment Compensation associated with their company
A list and status of appeals filed by their company or unemployed individuals against their company
An online area to complete Separation Information requests
An online area to file an appeal.

Employers, once registered, would begin session on “My Dashboard.” The dashboard allows employers to view the status of all their activity to date in Current User Statistics and other elements. Employers would have immediate access to Recruitment Services activities, such as Manage Jobs, Search for Candidates, etc.; Unemployment Services; My Recruitment Plan (Job Order Status, Resume's, and Virtual Recruiter); and access to their Message Center, correspondence, and Calendar.

The present invention system includes an optional Document Management and Imaging module. This supports a document repository within the system with desktop scanners. Document Management and Imaging functionality would be available to authorized staff. The elements and information in the Document Management system that can be available to a specific user type are controlled by privileges. These privileges are flexible.

The Document Management system's repository holds documents from desktop scans, bulk scans, and all system-generated documents associated with Workforce or Unemployment cases. For example, staff can view all the documents associated with a user. Staff would access documents while in the context of working with an employer or unemployed individual. A specific example is Workforce and/or unemployment compensation staff reviewing the birth certificate of a registrant. They would have immediate access to view the Birth Certificate, depending on their access privileges, through their view of the Document Management system—a WP Claim for Workforce staff or an Unemployment Claim for unemployment compensation staff.

These features support both Workforce and Unemployment claims and processes. For example, in the process of filing a claim for unemployment compensation, there are several important documents that are generated and sent to unemployed individuals and employers. All of these documents are saved to the document repository. In order to reasonably discuss a claim or problem situation with unemployed individuals or employers, it is often necessary to be able to see these documents and the information contained in them. Since all of these documents are in the repository, an inquiring unemployed individual, employer, or staff member can view the contents of the Document Tree to have a better understanding of the issues. Similarly, any document scanned in a bulk scan process could be linked or passed to the present invention Document Management system, and depending on access privileges, would be available to staff, unemployed individual, or employer.

The present invention system is enhanced with the Document Management and Imaging module to allow all users to view submitted or case documents controlled by privileges. The present invention Document Management and Imaging module could be configured to access the same data store as the unemployment compensation Benefits imaging system, hence sharing these documents.

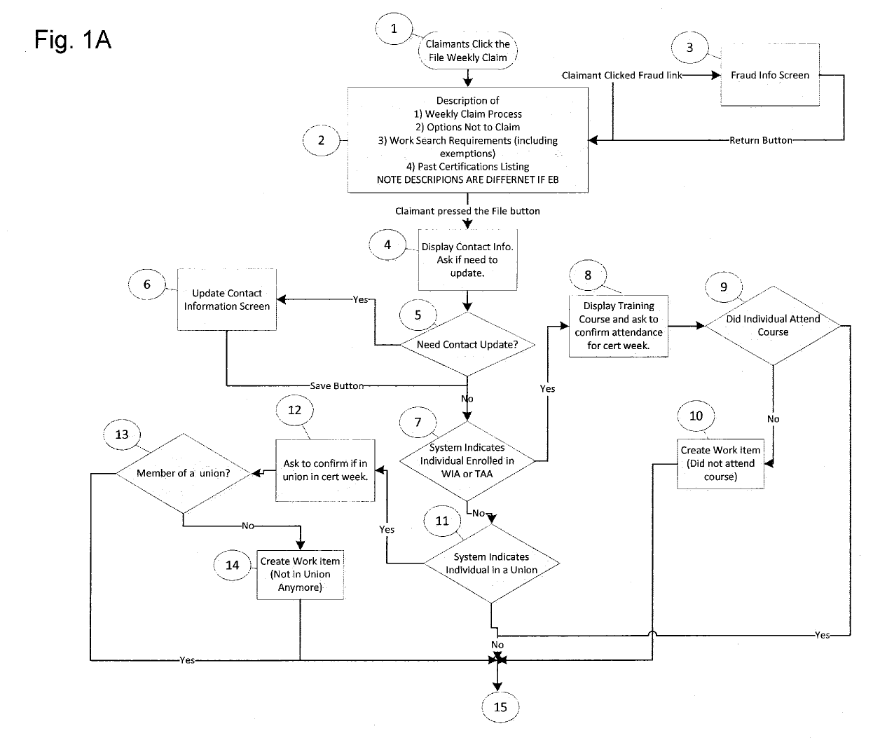

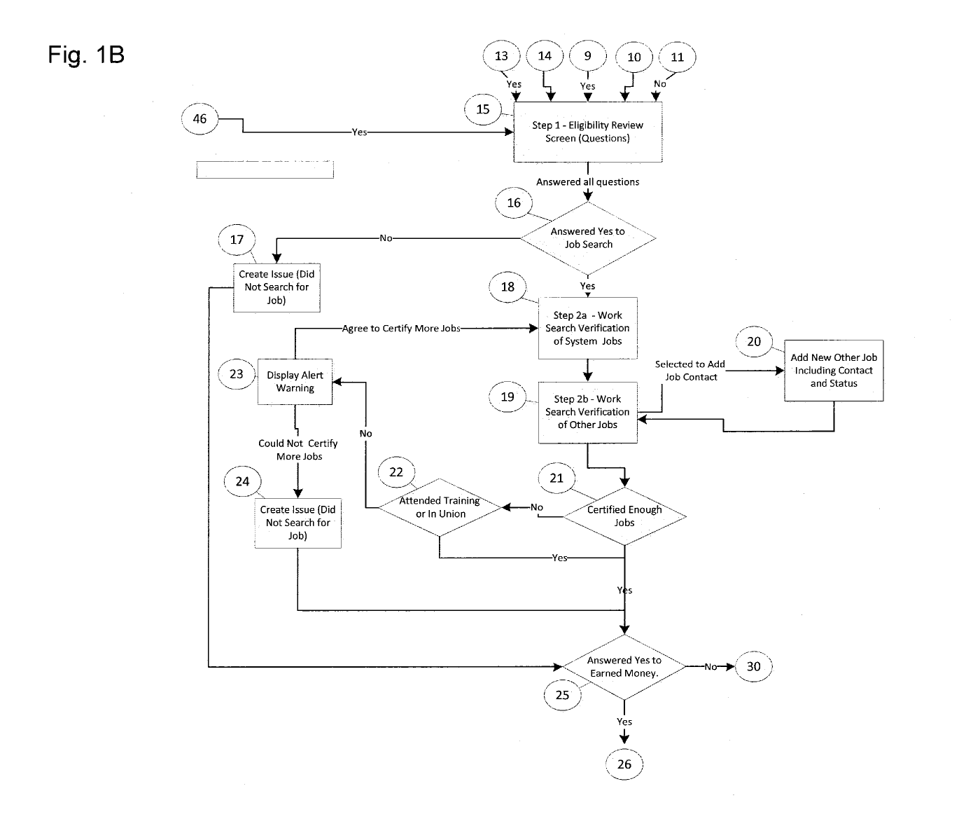

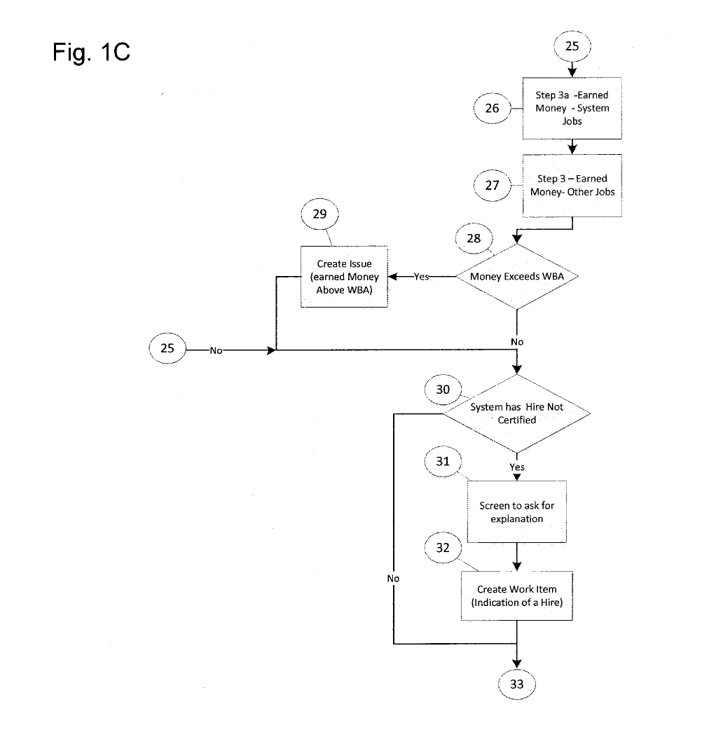

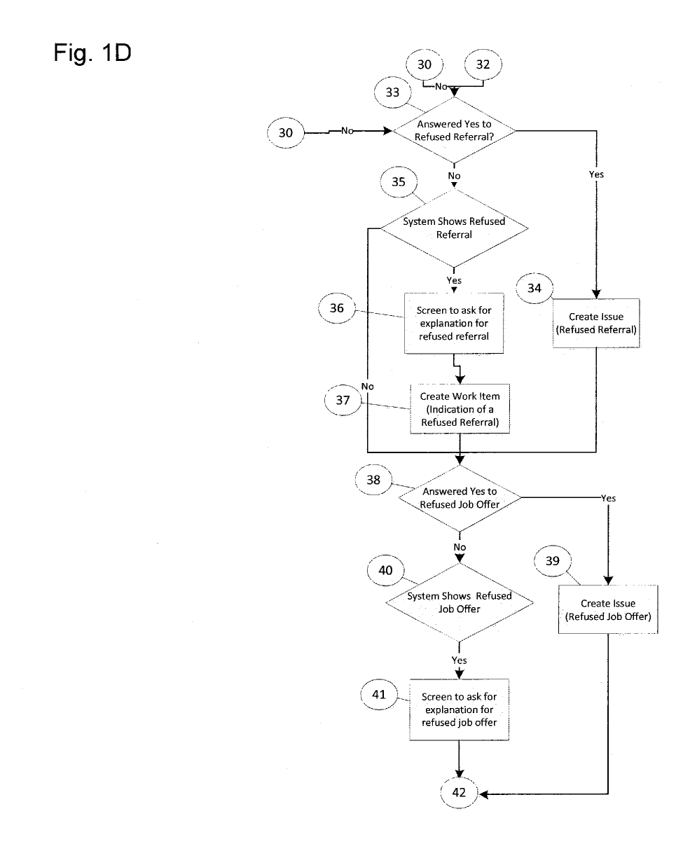

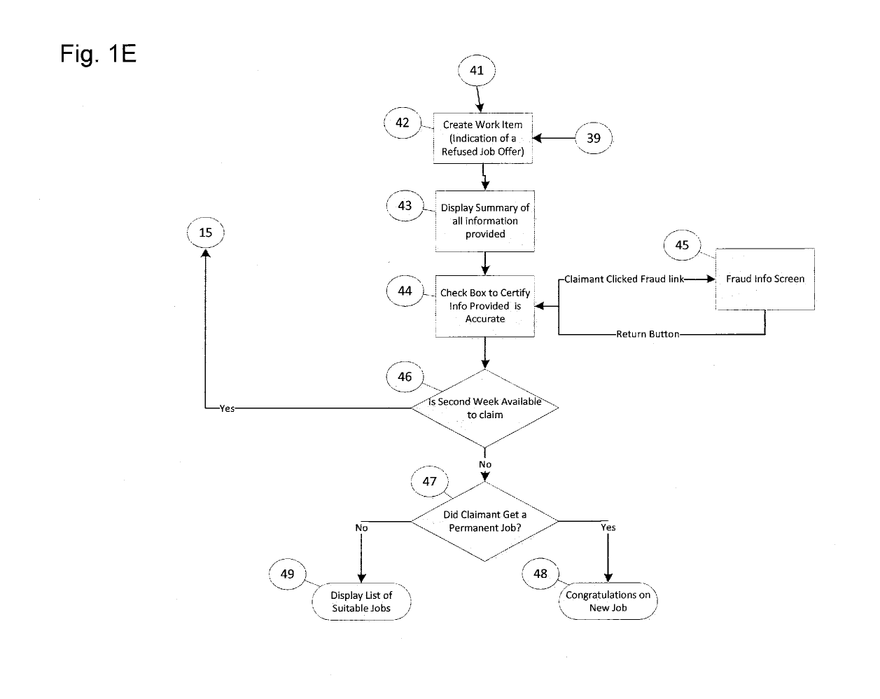

The Flow diagram of FIGS. 1A to 1E illustrates in flow-chart form one embodiment of the present invention. An individual with an unemployment insurance claim (“the claimant”) logs onto the re-employment system (“the system”). Using the displayed dashboard, the claimant clicks a link to file their weekly benefit certification 1. The system displays all the prior certification weeks along with week end dates, submission dates and claimant responses to the Eligibility Review Questions for that week 2. When the claimant clicks to certify a new week, the system verifies the program funding source of the UI claim (UI, employment benefits (EB), etc.) then displays the corresponding description of the weekly claim process. The description includes the claimant's options not to claim, a summary of all the statements they will be certifying, and the claimant's responsibility to seek full-time employment 4. If the claimant wants to read information on Unemployment Compensation Fraud, a link will take them to a new page giving detailed legal definitions of Unemployment Compensation Fraud along with phone numbers and websites for reporting it 3. When the claimant is ready to begin filing their weekly certification, they click the File button and the system displays their contact information for their review 5. The claimant has the option to update their contact information before continuing 6. To do so, the claimant uses the link provided to navigate to a new page where they can edit their contact information 7. When they save their changes, the system displays the new contact information for their review 5. From here, the claimant can click the Next button to begin Step 1.

In Step 1 of the weekly certification process, the system displays the state-mandated Eligibility Review Questions and requires the claimant to give a Yes or No response to each question. The headings above the questions display the end date of the certification week as well as the certification week number which represents the number of weeks since the claim first became effective 8. In Question 1, the claimant must respond Yes or No to: “Were you able and available to work each day?” 9. If the claimant answers No, they must provide an explanation. The No response also triggers the system to generate an issue and work item that prevents payment until reviewed by staff 10. The claimant's explanation is saved and later displayed to assist staff in making a determination on this issue. If the claimant answers Yes, no explanation is required and no issue or work item is generated. In Question 2, the claimant must respond Yes or No to: “Did you refuse any jobs offers?” 11. If the claimant answers Yes, they must provide an explanation. The Yes response also triggers the system to generate an issue and work item that prevents payment until reviewed by staff 12. The claimant's explanation is saved and later displayed to assist staff in making a determination on this issue. If the claimant answers No, no explanation is required and no issue or work item is generated. In Question 3, the claimant must respond Yes or No to: “Did you refuse any job referrals to a job?” 13. If the claimant answers Yes, they must provide an explanation. The Yes response also triggers the system to generate an issue and work item that prevents payment until reviewed by staff 14. The claimant's explanation is saved and later displayed to assist staff in making a determination on this issue. If the claimant answers No, no explanation is required and no issue or work item is generated. In Question 4, the claimant must respond Yes or No to: “Did you work or earn money?” 15. If the claimant answers Yes, the system sets an indicator which causes an additional page to display later in the certification process 16. (The additional page begins at 58). If the claimant answers No, the indicator is not set and the additional page will not display.

Before beginning the work search validation process, the system verifies several factors to determine whether the claimant is exempt from the work search requirement. First, the system verifies whether the claimant is a member of a labor union which finds work for its members 17. When the claimant is a union member, the system displays the union name and asks the claimant whether they were in the union during the certification week 18. The system records the claimant's response and proceeds accordingly 19. If the claimant answers No, the system creates an issue and work item that prevent payment until reviewed by staff 20. If the claimant answers Yes, the No Work Search indicator is set making the claimant exempt from the work search requirement 32; and, the system advances to the next verification test without creating an issue or work item.

Next, the system verifies whether the claimant is enrolled in an eligible training program through approved workforce programs 21. If the claimant is enrolled in approved workforce programs, the system displays the training course along with a question asking the claimant whether they attended classes during the certification week 22. The system records the claimant's response and proceeds accordingly 23. If the claimant answers No, the system creates an issue and work item that prevent payment until reviewed by staff 24. If the claimant answers Yes, the No Work Search indicator is set making the claimant exempt from the work search requirement 32; and, the system advances to the next verification test without creating an issue or work item.

Next, the system verifies whether the claimant has a defined recall date from an employer 25. If the claimant has a defined recall date, the system displays the employer name and recall date and asks the claimant if the information is valid for this certification week 26. The system records the claimant's response and proceeds accordingly 27. If the claimant answers No, the system creates an issue and work item that prevent payment until reviewed by staff 28. If the claimant answers Yes, the No Work Search indicator is set making the claimant exempt from the work search requirement 32; and, the system advances to the next verification test without creating an issue or work item.

Next, the system verifies whether the claimant is a Disaster Unemployment Assistance (DUA) claimant re-establishing their business 29. For those DUA claimants re-establishing their business, the system displays the claimant's DUA status and asks if the information is valid for this certification week 30. The system records the claimant's response and proceeds accordingly 31. If the claimant answers No, the system creates an issue and work item that prevent payment until reviewed by staff 33. If the claimant answers Yes, the No Work Search indicator is set making the claimant exempt from the work search requirement 32; and, the system advances to the job search verification without creating an issue or work item.

Now that the system has reviewed all the ways in which a claimant can be exempt from the work search requirement, the system verifies whether the claimant has performed a job search during the certification week 34. If the claimant has not used the system to perform a job search, the system verifies if any of the above verification tests triggered the No Work Search indicator 35. If the indicator is not set, the claimant is not exempt from the work search requirement, and the system begins the work search verification process (Step 2) 37. If the claimant is exempt, the system skips the entire work search verification process without creating an issue or work item.

In Step 2, the claimant must demonstrate they have performed a job search by submitting the minimum number of job contacts specified by the state. The claimant must also indicate for each job that they have actually contacted the employer and/or applied for the job. To complete this task in the system, the claimant works from a list that includes both system job contacts, those made using the system, and other job contacts, those made outside the system then entered manually by the claimant.

To begin the process, the system verifies whether the claimant used the system during the certification to conduct a job search. 38. If the claimant did not use the system during the certification week, only the claimant's other job contacts are considered 49. When the claimant has used the system during the certification week to view jobs, contact employers and/or apply for jobs, all these system jobs are listed on the page for the claimant to review. The list includes internally-posted jobs, those posted directly on the system by employers; as well as externally-posted jobs (spidered jobs), those brought into the system from third-party sources (Corporate webpages, private job boards, etc.). For each job, the system verifies whether the claimant indicated they contacted the employer 39. If the claimant merely viewed or expressed an interest in the job but did not contact the employer, the system will show an alert indicating that this job contact is not yet acceptable for inclusion in the claimant's work search total 40. The claimant will need to update their job contact status to indicate that they actually contacted the employer, applied for the job, scheduled an interview, etc. 41. If the claimant does not update their job contact status the system will continue to show an alert indicating that this job contact is not yet acceptable for inclusion in the claimant's work search total 42. If the claimant clicks on the link to update their job contact status, the system navigates to a new page where the claimant sees all the information on the selected employer and job title. On this page, the claimant may need to enter the contact person and contact method if it is not already part of the record 43. They will then need to update the status of the job application 44. When the claimant finishes updating a job application status, the system automatically includes it in the claimant's total job contacts for the week.

In addition to verifying the system job contacts, the system also verifies the claimant's other job contacts. If the claimant used the system during the certification week to manually add job contacts, those jobs are listed for the claimant to review 49. As with system jobs, the claimant may need to update the status of the job contact in order for it to be included in their total job contacts for the week. When the claimant needs to add additional job contacts in order to meet the state-mandated minimum, they can click to a new page where the system will assist them in entering the required information. In one instance, when the claimant enters their job title, the system automatically provides standard occupation titles and codes. In another instance, when the claimant enters the name of the employer, the system provides a database that will allow the claimant to prepopulate the employer's contact information 46. Finally, the claimant must update the job application status in order to make the job contact a part of the claimant's overall total for the week 47.

As the claimant adds and/or updates system and other jobs for inclusion in their job search requirement, the system displays a running total of the number of validated job contacts alongside the minimum number of job contacts mandated by the state. In this way the claimant always knows when they have fulfilled the requirement. Before the claimant can advance to the next step, the system verifies whether the claimant has completed enough job contacts to meet the certification requirement 52. When the claimant does not have enough job contacts, the system rechecks the No Work Search indicator to see whether the claimant is exempt from the work search requirement (35). If the indicator is set, the claimant is exempt and the system advances to the next step without creating an issue or work item. If the indicator is not set, when the claimant tries to leave the work verification page, the system verifies whether they need to certify more job contacts 48. If the claimant does not have enough certified job contacts, the system displays a warning indicating their current number of validated job contacts alongside the minimum number of job contacts mandated by the state 45. If the claimant agrees to stay on the page, they can continue adding to and updating their list of job contacts in order to increase their total number. If the claimant views the warning and chooses to continue, the system creates an issue and work item that prevent payment until reviewed by staff 50.

When the claimant has completed the work search verification, the system verifies whether the claimant has received a job placement during this certification week 53. Because employers use the system to post jobs and update the status of job openings, the system can verify whether an employer has indicated the claimant was hired on a date that falls within the certification week. If the claimant has received a job placement, the system displays the job placement information and asks the claimant if the information is valid 54. If the claimant answers No, the system asks the claimant to explain how the information is not accurate 55; and also creates an issue and work item that prevent payment until reviewed by staff 57. If the claimant answers Yes, the system asks if the job placement is a full-time long term position 56. If the claimant responds that it is not long term, the system creates an issue and work item that prevent payment until reviewed by staff 57. If the claimant responds that is long term, the system sets an indicator that the claimant has a confirmed permanent hire 70.

The system now verifies whether the claimant responded Yes in Question 4, “Did you work or earn money?” 58. If the claimant answers Yes, the system displays both the system jobs and other jobs associated with the claimant 59 and 61, respectively. If the claimant earned money from one of these jobs, they need only enter the amount earned and the days worked 60 and 62, respectively. If the employer is not listed among the system or other job contacts, the claimant must complete a new job contact page where system will assist them in entering the required job title and employer information (see 46 above). To complete the form, the claimant must also enter the amount earned and the days worked 63. The system compares the earnings claimed by the claimant for the certification week with the claimant's weekly benefit allowance 64. If the amount exceeds the claimant's weekly benefit allowance, and the claimant is filing on a stand-alone system, an issue and work item are generated that prevent payment until reviewed by staff. If the claimant is filing on an integrated system, no payment would be issued to the claimant and the reason would listed as Earnings Exceeded. 65.

Before the claimant can complete the weekly certification, the system displays a summary of all the information provided 66. The claimant is asked to review all the answers they have provided during the certification and check a box to certify that all information is accurate 67. If the claimant wants to re-read information on Unemployment Compensation Fraud, a link will take them to a new page giving detailed legal definitions of Unemployment Compensation Fraud along with phone numbers and websites for reporting it 68.

After the claimant has certified a week, the system verifies whether a second week is available to claim 69. With no second week available, the system now verifies whether the claimant confirmed the job placement information that was displayed for their review. If the claimant confirmed that the job placement information found in the system was accurate 54 and long term 56, the system concludes that the claimant began their permanent job on the start date indicated 70. Since the claimant has found a permanent job, the system displays a message of congratulations 72. When the claimant has not found a permanent job, and no second week is available to claim, the system displays an up-to-date list of suitable jobs so the claimant can continue searching for jobs in the system 71.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

1. A system for accessing unemployment insurance and workforce registration comprising in combination:
a database containing unemployment insurance benefit data;
a database containing workforce registration data;
a server having a software employment component, said software employment component operatively coupled to said database containing unemployment insurance benefit data and said software employment component operatively coupled to said database containing workforce registration data;
a first computer access terminal operatively coupled to said software employment component, the first computer access terminal allowing a first user to enter data into said database containing unemployment insurance benefit data and the first computer access terminal allowing the first user to enter data into said database containing workforce registration data;
a first dashboard on the first computer access terminal, the first dashboard allowing the first user access to an employment plan; and
an assessment tool, the assessment tool allowing the first user to determine suitability for selected occupations.

2. The system of claim 1 further comprising displaying on the computer access terminal a unified message center.

3. The system of claim 2 further comprising displaying on the first computer access terminal a calendar.

4. The system of claim 1 wherein the first user is unemployed.

5. The system of claim 1 further comprising allowing the first user access to update personal information from a status screen that is generated on the first computer access terminal.

6. The system of claim 1 further comprising displaying on the first computer access terminal a list of available jobs to the first user.

7. (canceled)

8. The system of claim 1 wherein the dashboard further comprising displaying on the first computer access terminal weekly certifications, outstanding claim issues, payments, adjustments and overpayments.

9. The system of claim 1 wherein the dashboard further comprising displaying on the first computer access terminal benefit amount, effective dates, and base period wages.

10. (canceled)

11. The system of claim 1 wherein the employment plan further comprising job applications, resumes and a virtual recruiter.

12. The system of claim 1 wherein the dashboard further comprising allowing the first user access to a benefits plan.

13. The system of claim 1 wherein the dashboard further comprising allowing the first user access to workforce functionality.

14. The system of claim 13 wherein the workforce functionality further comprising job market, virtual recruitment, new careers, and training classes.

15. The system of claim 1 wherein the dashboard further comprising allowing the first user access to unemployment services.

16. The system of claim 15 wherein the unemployment services further comprising weekly certifications.

17. The system of claim 1 further comprising a second computer access terminal operatively coupled to said software employment component, the second computer access terminal allowing a second user to access a second dashboard.

18. (canceled)

19. The system of claim 17 further comprising allowing the second user access to post a job, search for a candidate and review unemployment claims from the status screen that is generated on the second computer access terminal.

20. A system for accessing unemployment insurance and workforce registration comprising in combination:
a database containing unemployment insurance benefit data;
a database containing workforce registration data;
a server having a software employment component, said software employment component operatively coupled to said database containing unemployment insurance benefit data and said software employment component operatively coupled to said database containing workforce registration data;
a computer access terminal operatively coupled to said software employment component, the computer access terminal allowing a first user to log on and enter data into said database containing unemployment insurance benefit data and the computer access terminal allowing the first user to log on and enter data into said database containing workforce registration data, the computer access terminal allowing a second user to log on and review unemployment claims;
an assessment tool, the assessment tool allowing the first user to determine suitability for selected occupations; and
a dashboard operatively coupled to the computer access terminal.

21. The system of claim 20 wherein the dashboard further comprising displaying on the computer access terminal weekly certifications, outstanding claim issues, payments, adjustments and overpayments.

22. The system of claim 20 further comprising displaying on the computer access terminal a list of available jobs to the first user at log on.

23. The system of claim 20 further comprising allowing access to the first user at log on to online job searching.

24. The system of claim 20 further comprising electronically storing the first user's job search; and allowing the first user to use the stored job search for fulfilling weekly job search requirements for unemployment benefits.
